(19) United States
(12) Patent Application Publication
(10) Pub. No.: US 2014/0224000 A1
(43) Pub. Date: Aug. 14, 2014

(54) Estimating Oil Viscosity

(71) Applicants: Kentaro Indo, Sugar Land, TX (US); Huang Zeng, Edmonton (CA); Yuesheng Cheng, Edmonton (CA); Patrice Abivin, Sugar Land, TX (US)

(72) Inventors: Kentaro Indo, Sugar Land, TX (US); Huang Zeng, Edmonton (CA); Yuesheng Cheng, Edmonton (CA); Patrice Abivin, Sugar Land, TX (US)

(73) Assignee: SCHLUMBERGER TECHNOLOGY CORPORATION, Sugar Land, TX (US)

(21) Appl. No.: 14/234,576

(22) PCT Filed: Jul. 3, 2012
(86) PCT No.: PCT/US12/45381

§ 371 Date: Apr. 24, 2014

Related U.S. Application Data
(60) Provisional application No. 61/512,242, filed on Jul. 27, 2011.

(51) Int. Cl. G01N 11/00; E21B 47/00

(52) U.S. Cl. CPC G01N 11/00; E21B 47/00; G01N 2011/0093
USPC 73/54.42; 73/152.18

(57) ABSTRACT

A technique facilitates estimation of the viscosity of heavy oil. The method comprises evaluating a sample of oil by using an infrared spectrum sensor to obtain a reference temperature based on infrared absorbance. The reference temperature can then be used to determine viscosity data on the sample at a given temperature or temperatures.

### CROSS-REFERENCE TO RELATED APPLICATION

The present application claims priority to U.S. Provisional Application 61/512,242, filed Jul. 27, 2011, and incorporated herein by reference.

### BACKGROUND

Heavy oil resources distributed throughout the world are almost double the quantity of conventional oil resources. With conventional oil depletion and increasing global demand, the importance of heavy oil reservoir exploration and production is well recognized worldwide. However, the high viscosity of unconventional heavy oils can require additional or alternate techniques to facilitate their recovery. Some recovery operations reduce the oil viscosity by thermal recovery methods which rely on increasing temperature to reduce the viscosity of heavy oils. Understanding heavy oil viscosity-temperature behavior can play a role in reservoir delineation, development, and production.

The viscosity of liquids in general and heavy oils in particular is highly dependent on their chemical composition and thermodynamic properties, such as the temperature and the pressure. From a compositional perspective, it is very difficult to anticipate the viscosity of a hydrocarbon fluid, especially a heavy oil, the composition of which is very complex and the viscosity of which can vary by orders of magnitude depending on its origins. U.S. Pat. No. 6,892,138 discloses a method to obtain the in situ viscosity of hydrocarbons by using an empirical relation between the optical density of the fluids at predetermined short wavelengths. This method relies on the consistency of a database of different oils from the same geological area, which is used to prepare the empirical model.

Recently, it has been shown that the thermal behaviors of heavy oils from all over the world are very similar from one heavy oil to another. In particular, it appears possible to design a universal model for the temperature dependence of heavy oils, which obeys a non-Arrhenius like behavior. Based on this observation, the empirical power law equation disclosed in US Patent Application Publication US 2010/0043538 was developed. Providing a unique reference temperature for each heavy oil, it allows estimation of the viscosity of the fluid over a large range of temperatures (from 25° C. to 200° C.). Once the reference temperature is calculated from a viscosity measurement at one temperature, the viscosity of the hydrocarbon fluid can be evaluated at the different temperatures the fluid experiences during the production process, from the reservoir to the transport lines.

In this model, the reference temperature is thus a very important parameter to evaluate the viscosity of a crude oil and it is obvious that the sooner this parameter is known, the better. Being able to predict the viscosity of a crude oil at different temperatures is a decisive advantage to design optimized production and transport facilities. It would thus be of interest to obtain the reference temperature from early in-situ measurements. However, since the viscosity measurement of oil is still challenging in situ using a well tool, other techniques, such as optical properties, may be necessary. For example, Schlumberger has designed a well logging tool which can measure the optical density of a hydrocarbon fluid at selected wave lengths (see DFA Asphaltene Gradients for Assessing Connectivity in Reservoirs under Active Gas Charging, SPE 145438, SPE Annual Technical Conference and Exhibition, Denver, Colo., USA, 30 October-2 Nov. 2011), data from which may be used to calculate the reference temperature of a crude oil.

### SUMMARY

In general, the present disclosure provides a methodology and system for estimating the viscosity of a heavy oil. The method comprises evaluating a sample of oil by using an infrared spectrum sensor to obtain a reference temperature based on infrared absorbance. The reference temperature can then be used to determine viscosity data on the sample at a given temperature or temperatures.

### BRIEF DESCRIPTION OF THE DRAWINGS

Certain embodiments will hereafter be described with reference to the accompanying drawings, wherein like reference numerals denote like elements. It should be understood, however, that the accompanying figures illustrate only the various implementations described herein and are not meant to limit the scope of various technologies described herein.

FIG. 1 is a schematic illustration of an example of a system for estimating viscosity of a heavy oil obtained from a subterranean formation, according to an embodiment of the disclosure.

FIG. 2 is a schematic illustration of a processor-based system for processing data to estimate viscosity, according to an embodiment of the disclosure.

FIG. 3 is a graphical representation of optical spectra of heavy oil, according to an embodiment of the disclosure.

FIG. 4 is a graphical representation of a correlation coefficient between infrared spectra of heavy oils and wavenumber, according to an embodiment of the disclosure.

FIG. 5 is a graphical representation of a linear correlation between reference temperature and infrared absorbance on heavy oil, according to an embodiment of the disclosure.

FIG. 6 is a graphical representation of reference temperature obtained versus reference temperature predicted from the infrared spectrum, according to an embodiment of the disclosure.

FIG. 7 is a graphical representation of measured and predicted viscosity over a temperature range, according to an embodiment of the disclosure.

FIG. 8 is a flowchart representing a process for estimating heavy oil viscosity from infrared measurement, according to an embodiment of the disclosure.

### DETAILED DESCRIPTION

In the following description, numerous details are set forth to provide an understanding of some illustrative embodiments of the present disclosure. However, it will be understood by those of ordinary skill in the art that the system and/or methodology may be practiced without these details and that numerous variations or modifications from the described embodiments may be possible.

The disclosure herein generally relates to a methodology and system for measurement of fluid properties. As described in greater detail below, the methodology and system may be used to estimate the viscosity of heavy oil, at a range of temperatures based on the infrared (IR) optical spectrum and based on an empirical power law equation, such as the power law equation disclosed in US Patent Application Publication US 2010/0043538.

By way of example, the technique may be used to estimate viscosity of heavy oil at temperatures ranging from, for example, 25° C. to 200° C. Additionally, the technique enables estimates based on small sample quantities with testing occurring over relatively short periods of time. For example, estimates of heavy oil viscosity may be obtained in approximately one minute or less for heavy oil samples having viscosities in the range from 1000 centipoise (cP) to 1,000,000 cP at room temperature and for sample volumes of one droplet or less.

Referring generally to FIG. 1, an example of one type of application is illustrated as utilizing an infrared spectrum sensor, e.g. an infrared spectrum analyzer, mounted on a well tool for delivery to a subterranean heavy oil reservoir. The example is provided to facilitate explanation, and it should be understood that a variety of infrared spectrum sensors may be employed in well or non-well related applications according to the methodology described herein. The infrared spectrum sensor may be used to facilitate estimation of the viscosity of liquid samples in wellbores, at other subterranean locations, at surface locations, or at other locations having liquid, e.g. heavy oil, to be sampled. The viscosity evaluation system may comprise a variety of sampling mechanisms, sensors, deployment components, control systems, data processing systems, and other devices and systems arranged in various configurations depending on the parameters of a specific evaluation application.

In FIG. 1, a system 20 for obtaining and processing heavy oil samples in situ is illustrated. According to an embodiment of system 20, a well tool 22 is deployed to a subterranean sampling location 24. For example, the well tool 22 can be deployed downhole into a wellbore 25 via a conveyance 26 to a subterranean formation 28. The well tool 22 may comprise a variety of components and/or the well tool 22 may be part of a larger well system. In the example illustrated, however, well tool 22 comprises a sampling system 30 designed to obtain one or more samples at the sampling location 24. Sampling system 30 may comprise a variety of components, such as extendable tubes, mandrels, scrapers, ports, and/or other features designed to obtain the desired sample of heavy oil or other hydrocarbon liquid.

In the example illustrated, the well tool 22 further comprises an infrared (IR) spectrum sensor 32. The infrared spectrum sensor 32 may comprise an infrared spectrum analyzer or other type of optical sensor capable of detecting infrared absorbance. The sample obtained by sampling system 30 is analyzed by infrared spectrum sensor 32 to determine the infrared absorbance of the sample. In some applications, the well tool 22 may also comprise a temperature control 34 used to adjust the temperature of the sample prior to measuring infrared absorbance via infrared spectrum sensor 32. In some applications, the sample is adjusted to a desired temperature prior to testing, e.g. adjusted to approximately room temperature of, for example, 22° C. to 26° C.

The well tool 22 may also comprise electronics 36 designed to control operation of sampling system 30, infrared spectrum sensor 32, and/or temperature control 34. The electronics 36 may be part of an overall control system 38, such as a processor-based control system used to process sample data as described in greater detail below. In the example illustrated in FIG. 1, a processor-based control system 38 is employed and may be designed to process data at the subterranean location and/or at a surface location via a surface control portion 39 of the overall control system 38.

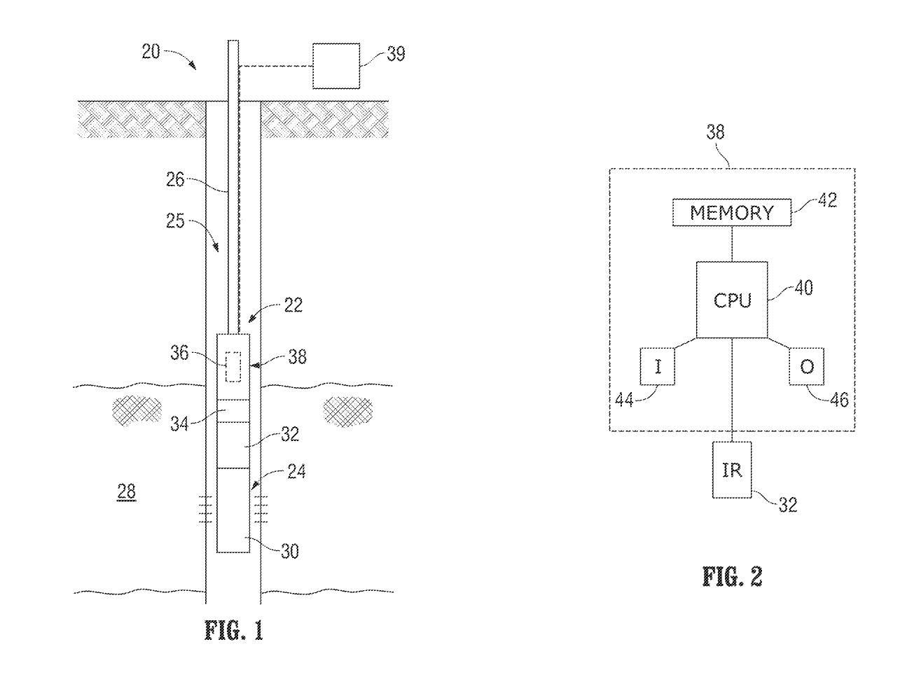

An example of a processor-based control system 38 is illustrated in FIG. 2 as operatively coupled with infrared spectrum sensor 32. The processor system 38 may be designed to perform the processing function at the subterranean location, e.g. sampling location 24, at a surface location, or at a combination of the subterranean location and the surface location. Accordingly, control system 38 may be provided on a single system or a plurality of systems which work in cooperation. In some applications, the infrared spectrum sensor 32 also may comprise at least some processing capability and, in such an embodiment, form a part of the overall control system 38.

As illustrated in FIG. 2, the processor-based control system 38 may be in the form of a computer-based system having a processor 40, such as a central processing unit (CPU). The processor 40 is operatively employed to intake data, process data, and run various equations/algorithms. The processor 40 may also be operatively coupled with a memory 42, an input device 44, and an output device 46, as well as infrared spectrum sensor 32. Input device 44 may comprise a variety of devices, such as a keyboard, mouse, voice recognition unit, touchscreen, other input devices, or combinations of such devices. Output device 46 may be positioned at a surface location and may comprise a visual and/or audio output device, such as a computer display, monitor, or other display medium having a graphical user interface. Additionally, the processing may be done on a single device or multiple devices on location, away from the sampling location, or with some devices located on location and other devices located remotely. Once the desired viscosity calculations are performed, viscosity data may be stored in memory 42 for future reference and/or use.

The processor-based control system 38 is used in cooperation with infrared spectrum sensor 32 to enable rapid estimates of the viscosity of heavy oil or other liquids at a variety of selected temperatures based on the infrared optical spectrum and a power law equation, as discussed in greater detail below. The infrared spectrum sensor 32 detects infrared absorbance when molecules resonate due to exposure to electromagnetic waves, such as infrared light. Basically, a molecule resonates when exposed to electromagnetic waves (light) and absorbs at a specific energy determined by molecular orbital, vibration and bonding structure, and the mass of the atoms, if the energy of the light matches the energy gap in the molecules.

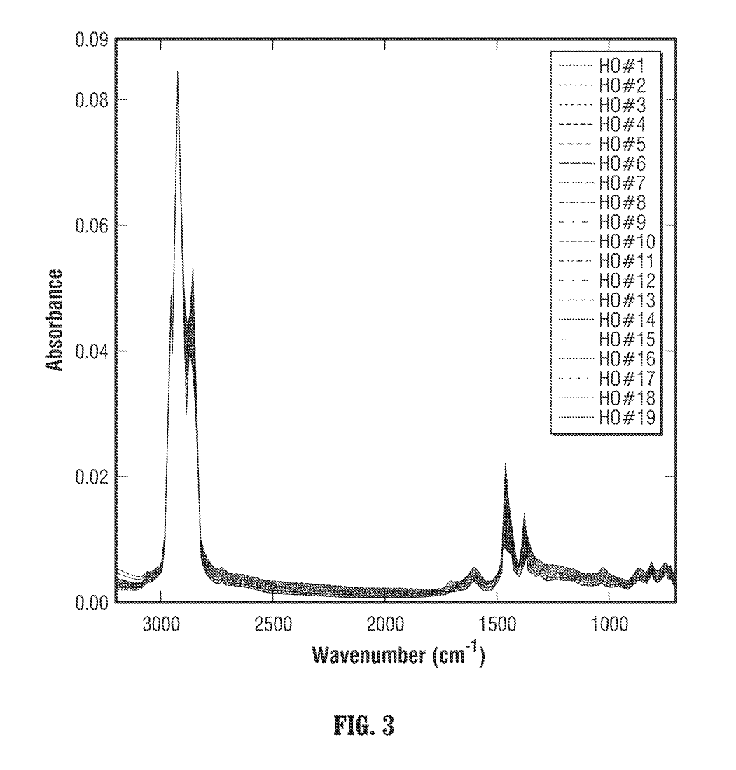

Because the energy is unique depending on the molecules, molecules have a specific absorption pattern on the IR spectrum. Therefore, the IR spectrum can be utilized for structural and compositional analyses on chemical compounds. In contrast, the electronic energy absorption of a molecule mainly occurs in the ultraviolet (UV) and visible range, while the vibration energy absorptions are present in the IR range. In the graphical representation of FIG. 3, the IR absorbance spectra of several different heavy oils (19 different heavy oils) are illustrated. The spectral pattern is unique depending on the chemical composition of the crude oil. Therefore, IR as well as UV-visible spectral measurement techniques have been found to be useful for crude oil analysis. As well as chemical composition, the IR spectra can link to other properties of crude oils because fluid properties are governed by chemical composition and interaction between the molecules. As discussed herein, system 20 utilizes an IR measurement technique which can be used to estimate the viscosity of crude oil, e.g. the viscosity of heavy oil.

The system 20 can be readily employed in heavy oil environments and utilizes an IR absorbance spectrum to estimate heavy oil viscosity via estimating reference temperature Tᵣ in a power law equation, such as:

In η=a+b(T/Tᵣ)^{c} (1)

where η and Tᵣ are viscosity (in cP) and reference temperature (in ° K) of a heavy oil, respectively, and a, b and c are constants. By way of example, Tᵣ can be a glass transition temperature of heavy oil. In addition, constants a, b and c may be selected to be −0.5734, 20.4095 and −3.3018, respectively. The constants a, b and c have been established based on analysis of 14 heavy oil samples. (See, for example, US Patent Application Publication US 2010/0043538 which empirically determined the constants a, b and c from viscosity data of 14 heavy oil samples in the temperature range from 25° C. to 200° C.). Once the constants are entered, the power law equation becomes:

In η=−0.5734+20.4095(T/Tᵣ)^{-3.3018} (2)

This equation gives an empirical relationship between heavy oil viscosity and reference (also referred to as glass transition) temperature, meaning that viscosity η at temperature T can be estimated from this equation if Tᵣ is known. The present system and methodology estimate heavy oil viscosity via Tᵣ determined from the IR spectrum and by substituting Tᵣ into Equation (2).

FIG. 3 illustrates IR absorbance spectra of 19 heavy oil samples at wavenumbers ranging from 3200 cm⁻¹ to 700 cm⁻¹. Sharp peaks around 2900 cm⁻¹ and 1400 cm⁻¹ are absorption of stretching and bending modes of —CH₂ or —CH₃. Other vibrational modes of hydrocarbon molecules also are observed below 1300 cm⁻¹ (the so called fingerprinting region). It is, however, difficult to assign a functional group to each peak exactly in this region because the shape of the peaks is broad and many absorption peaks of functional groups are overlapping each other. Because a functional group governing heavy oil viscosity is unknown, a Pearson product-moment correlation coefficient between Tᵣ and the set of the IR spectra at each band can be calculated to find the band of a functional group correlating with Tᵣ. The Pearson product-moment correlation is given below as:

$$corr ( {T}_{r} , IR ( {λ}_{i} ) ) = \frac{cov ( {T}_{r} , IR ( {λ}_{i} ) )}{{σ}_{Tr} \cdot {σ}_{{IR}_{λ}}} \qquad ( 3 )$$

where cov(x, y) is the covariance of data set x and y, and σₓ is a standard deviation of x. The correlation gives a coefficient value between −1 and 1. (1: strongly correlating linearly, −1: negatively correlating linearly, 0: no correlation at all). Alternatively, another multivariate analysis method, e.g. partial least square regression (PLSR), principal component regression (PCR), or artificial neural network (ANN), can be used to correlate between IR spectra and the reference temperature.

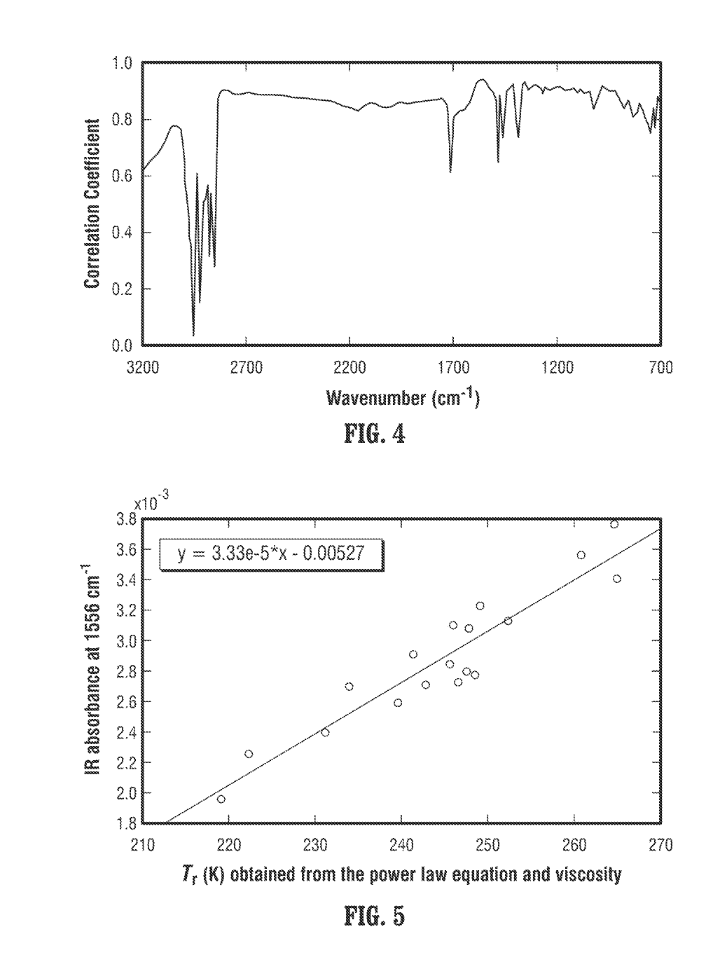

The reference temperature, Tᵣ of each heavy oil is predetermined from Equation (2) and the known viscosity may be measured and established with a capillary viscometer at 25° C. For example, FIG. 4 illustrates the correlation coefficient of the heavy oil sample set with the reference temperature as a function of wavenumber. As mentioned above, the reference temperature of each sample may be obtained from Equation (2) with the viscosity being determined at, for example, 25° C. As illustrated, the highest value of the correlation coefficient is 0.941 at 1556 cm⁻¹.

Referring generally to FIG. 5, the linear correlation between Tᵣ and IR absorbance at 1556 cm⁻¹ is illustrated where the highest value of the correlation coefficient is present as mentioned above. It should be noted that data on two heavy oils used in preparing the graph of FIG. 3 did not contribute to the data in FIG. 5 because no viscosity data was available. The slope and intercept of the linear function, y=a*x+b have been determined to be 3.33e-5 and −0.00527, respectively. These coefficients may depend on, for example, measurement parameters of an instrument, type of attenuated total reflectance (ATR) crystal, and wavenumber to be selected. Therefore, calibration of the infrared spectrum sensor 32 can be performed with heavy oils with known viscosity to increase accuracy. Then, Tᵣ can be estimated from this correlation and the IR absorbance.

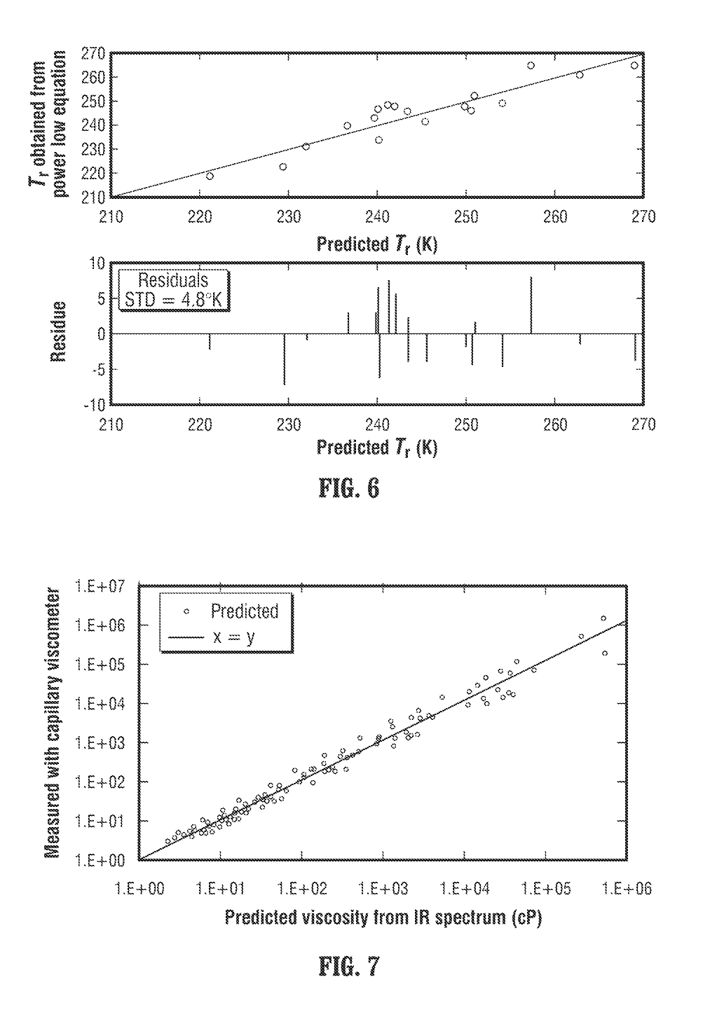

FIG. 6 illustrates the comparison of Tᵣ predicted from the IR spectrum and that obtained from the power law equation with measured viscosity at 25° C. (top) and its residues (bottom). To assess this method, the Leave-One-Out cross validation method was carried out. As a result, reference temperatures, Tᵣ, of heavy oils were predicted with 4.8° K of standard deviation (STD). The Partial Least Squares (PLS) method was also used to predict Tᵣ and a similar standard deviation was obtained. Moreover, by substituting the predicted Tᵣ and temperature in Equation (2), the viscosity of heavy oils (e.g. heavy oils 1-19 illustrated in FIGS. 3 and 5) from 25° C. to 200° C. can be estimated as shown in FIG. 7. In this example, standard deviation from measured viscosity in the entire range of viscosity (2.3 cP˜572,000 cP) is approximately 48%. Standard deviations in the viscosity range below 100 cP, 100 cP˜1000 cP, 1000 cP˜10,000 cP and >10,000 cP are 33%, 45%, 65% and 70%, respectively.

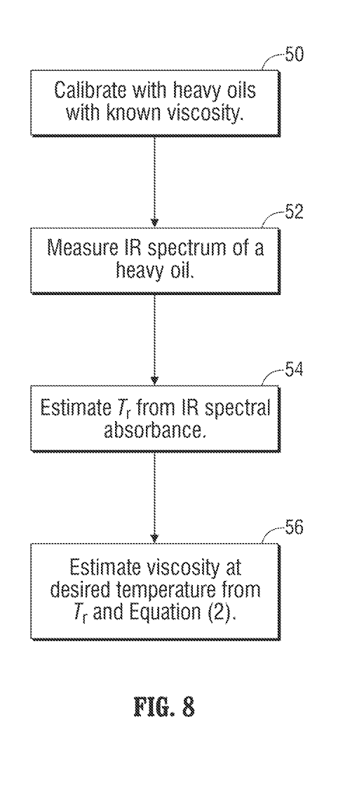

Referring generally to FIG. 8, a flowchart is illustrated to provide an example of a methodology for determining the viscosity of heavy oils from the IR spectrum. Initially, calibration of the infrared spectrum sensor 32 may be performed with heavy oil of known viscosity, as represented by block 50. The initial calibration can be helpful because the IR spectrum is influenced by measurement parameters as mentioned above. For the calibration, at least two heavy oils may be used to obtain a linear calibration function. Subsequently, the IR spectrum is measured for a sample of the heavy oil, as indicated by block 52. As discussed above, use of the infrared spectrum sensor 32 enables analysis of a small volume sample, such as a droplet sized sample.

The IR spectrum is measured to estimate reference temperature, Tᵣ, from IR spectral absorbance, as indicated by block 54. Estimation of the reference temperature from IR spectral absorbance is at a particular wavenumber (e.g. 1556 cm⁻¹) and is also based on the linear calibration function obtained from the calibration referenced in block 50. Subsequently, Tᵣ obtained from the IR spectrum and temperature are substituted in Equation (2) to obtain the estimation of heavy oil viscosity, as indicated by block 56 of FIG. 8.

The system and methodology described herein may be employed in well applications and in non-well related applications with respect to oil or other liquids. However, the system and methodology are useful in evaluating heavy oils of a variety of types, at a variety of temperatures, and from many environments. The system and methodology may be employed in many types of applications with a variety of other tools, systems, and components. For example, the infrared spectrum sensor 32 may comprise various IR spectrum analyzers or other optical sensors able to perform suitable IR spectrum detection. Similarly, many types of sampling tools, temperature control tools, control systems, and other components may be employed in various combinations in subterranean applications and/or surface applications.

Although only a few embodiments of the system and methodology have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A method for estimating heavy oil viscosity, comprising:
obtaining a sample of a heavy oil;
using an infrared spectrum sensor to obtain a reference temperature, Tᵣ in ° K, for the heavy oil sample based on infrared absorbance; and
determining a viscosity, η in cP, of the sample at a temperature, T in ° K, according to an equation of the form:
In η=a+b(T/Tᵣ)^{c},
where a, b, and c are constants.

2. The method as recited in claim 1, wherein a, b, and c are −0.5734, 20.4095, and −3.3018, respectively.

3. The method as recited in claim 1, further comprising calibrating the infrared spectrum sensor with heavy oil of known viscosity.

4. The method as recited in claim 3, wherein calibrating comprises obtaining a linear calibration function using at least two different heavy oils.

5. The method as recited in claim 1, wherein using an infrared spectrum sensor and determining a viscosity are performed automatically via the infrared spectrum sensor and a processor-based control system.

6. The method as recited in claim 1, wherein determining the viscosity of the sample is performed while the sample is at room temperature.

7. The method as recited in claim 1, wherein obtaining the sample comprises obtaining the sample in a volume of one droplet or less.

8. The method as recited in claim 1, wherein determining a viscosity comprises determining viscosity while at a downhole location.

9. A method for estimating viscosity, comprising:
estimating a reference temperature, Tᵣ in ° K, of an oil sample based on an infrared spectrum of the oil sample;
using a processor-based system to establish a viscosity, η in cP, of the oil sample at a temperature, T in ° K, by using the reference temperature in the equation:
In η=a+b(T/Tᵣ)^{c},
where a, b, and c are constants; and
outputting viscosity information to a display device.

10. The method as recited in claim 9, wherein estimating a reference temperature comprises using an infrared spectrum sensor deployed downhole into a wellbore.

11. The method as recited in claim 9, wherein estimating a reference temperature comprises:
using an infrared spectrum sensor to determine the reference temperature, Tᵣ, based on infrared absorbance; and
selecting the constants a, b, and c as −0.5734, 20.4095, and −3.3018, respectively.

12. The method as recited in claim 11, further comprising calibrating the infrared spectrum sensor with heavy oil of known viscosity.

13. The method as recited in claim 12, wherein calibrating the infrared spectrum sensor comprises obtaining a linear calibration function using at least two different heavy oils.

14. The method as recited in claim 9, wherein using a processor-based system to establish a viscosity, η, comprises calculating the viscosity on the processor-based system located at least partially downhole in a wellbore.

15. The method as recited in claim 14, wherein outputting viscosity information comprises outputting the viscosity information to the display device at a surface location remote from the wellbore.

16. The method as recited in claim 9, wherein estimating a reference temperature, Tᵣ, comprises estimating the reference temperature on the oil sample obtained from a heavy oil with a viscosity in the range of 1000 cP to 1,000,000 cP at room temperature.

17. A system for determining viscosity of an oil, comprising:
an infrared spectrum sensor to determine infrared absorbance of an oil sample; and
a processing system employed to determine a reference temperature, Tᵣ in ° K, based on the infrared absorbance of the oil sample and to estimate a viscosity, η in cP, of the oil sample at temperature, T in ° K, by processing the values according to the equation:
In η=a+b(T/Tᵣ)^{c},
where a, b and c are constants.

18. The system as recited in claim 17, wherein at least a portion of the processing system is contained in the infrared spectrum sensor.

19. The system as recited in claim 17, wherein the constants a, b, and c are −0.5734, 20.4095, and −3.3018, respectively.

20. The system as recited in claim 17, wherein the infrared spectrum sensor is disposed on a well tool which is lowered into a wellbore to obtain the oil sample, and wherein the processing system comprises a display for providing information regarding the viscosity of the oil sample.
